(19) United States
(12) Patent Application Publication
(10) Pub. No.: US 2010/0254358 A1
(43) Pub. Date: Oct. 7, 2010

(54) WIRELESS NETWORK CONNECTING AND SETTING METHOD AND APPLICATION THEREOF

(75) Inventors: Wei-Cheng HUANG, Taipei County (TW); Mei-Yi TSAI, Taipei County (TW); Chih-Liang CHOU, Taipei County (TW)

Correspondence Address: BRIAN M. MCINNIS, 12th Floor, Ruttonjee House, 11 Duddell Street, Hong Kong, HK

(73) Assignee: CHICONY ELECTRONICS CO., LTD., Taipei County (TW)

(21) Appl. No.: 12/512,033

(22) Filed: Jul. 30, 2009

(30) Foreign Application Priority Data
Apr. 7, 2009 (TW) 98111561

(51) Int. Cl. H04W 4/00; H04K 1/00; G06F 15/16

(52) U.S. Cl. 370/338; 380/270; 709/227

(57) ABSTRACT

A wireless network connecting and setting method includes the following steps; a detect signal is transmitted through a first wireless network device; a detect reply is replied to the first wireless network device when the detect signal is received by a second wireless network device; a wireless access point (AP) profile of the first wireless network device, according to which the first wireless network device connects to a wireless AP, is transmitted to the second wireless network device; the second wireless network device is connected to the wireless AP according to the wireless AP profile, such that the second wireless network device connects to a network through the wireless AP.

### RELATED APPLICATIONS

This application claims priority to Taiwan Application Serial Number 98111561, filed Apr. 7, 2009, which is herein incorporated by reference.

### BACKGROUND

1. Field of Invention

The present invention relates to a network connecting and setting method and application thereof. More particularly, the present invention relates to a wireless network connecting and setting method and application thereof.

2. Description of Related Art

Since network service can be obtained through wireless network without a network cable connected, wireless network service becomes more and more popular. In addition, as transmission rate of wireless network develops, more and more devices, such as computers, Personal Digital Assistants (PDAs), Internet Protocol (IP) cameras, Digital Photo Frame (DPF), apply wireless network for network connection.

Wherein, a wireless network device connects to a wireless Access Point (AP) wirelessly according to a wireless AP profile before obtaining network service through wireless network. Then, the wireless network device can obtain network service through the wireless AP wirelessly connected. Wherein, the wireless AP profile may include Service Set Identifier (SSID) of the wireless AP, an encryption method utilized by the wireless AP, a key to the encryption method utilized by the wireless AP, or any other information related to the wireless AP. Above all, setting the wireless AP profile for the wireless network device is very complicated and always disturbs users.

### SUMMARY

According to one embodiment of this invention, a wireless network connecting and setting method is provided. The wireless network connecting and setting method includes the following steps: a detect signal is transmitted through a first wireless network device. A detect reply is replied to the first wireless network device when the detect signal is received by a second wireless network device. A wireless AP profile of the first wireless network device, according to which the first wireless network device connects to a wireless AP, is transmitted to the second wireless network device. The second wireless network device is connected to the wireless AP according to the wireless AP profile. Then, the second wireless network device can connect to a network through the wireless AP.

According to another embodiment of this invention, a wireless network connecting method is provided. The wireless network connecting method is executed by a first wireless network device, such that the first wireless network device obtains a wireless AP profile of a second wireless network device from the second wireless network device. Then the first wireless network device connects to a wireless AP according to the wireless AP profile for network surfing. The wireless network connecting method includes the following steps: a detect signal is received from the second wireless network device. A detect reply is replied to the second wireless network device. The wireless AP profile of the second wireless network device, according to which the second wireless network device connects to the wireless AP, is obtained from the second wireless network device. The wireless AP is connected according to the wireless AP profile for connecting to a network through the wireless AP.

According to still another embodiment of this invention, a wireless network setting method is provided. The wireless network setting method is executed by a first wireless network device, such that the first wireless network device transmits a wireless AP profile of the first wireless network device to a second wireless network device. Then the second wireless network device can connect to a wireless AP according to the wireless AP profile for network surfing. The wireless network setting method includes the following steps: a wireless network setting program is executed. Detect if there is the second wireless network device. Determine if the wireless AP profile can be utilized for connecting to the wireless AP. Only when there is the second wireless network device detected and the wireless AP profile can be utilized for connecting to the wireless AP, the wireless AP profile is transmitted to the second wireless network device. Then, the second wireless network device can connect to the wireless AP according to the wireless AP profile for connecting to a network through the wireless AP.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiments, with reference made to the accompanying drawings as follows:

FIG. 1 is a block diagram of a wireless network system according to an embodiment of this invention;

FIG. 2 is an embodiment of a wireless network connecting method executed in the second wireless network device 130 in FIG. 1; and

FIG. 3 is an embodiment of a wireless network setting method executed in the first wireless network device 120 in FIG. 1

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

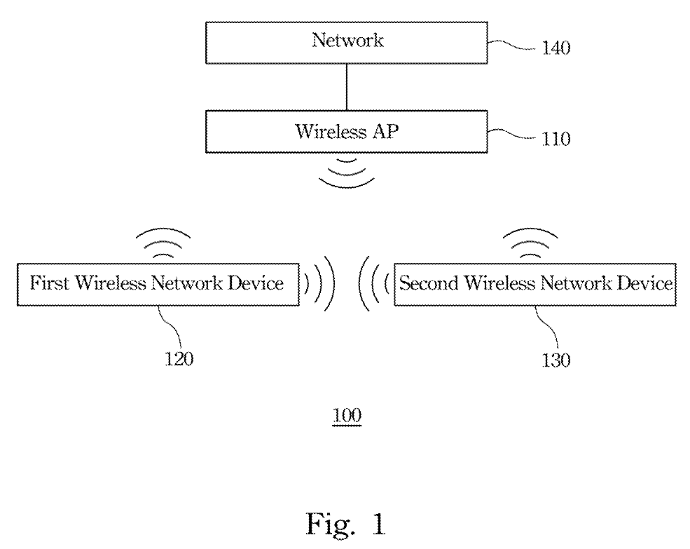

FIG. 1 is a block diagram of a wireless network system according to an embodiment of this invention. The wireless network system 100 includes a wireless Access Point (AP) 110, a first wireless network device 120 and a second wireless network device 130. The second wireless network device 130 obtains a wireless AP profile of the first wireless network device 120 from the first wireless network device 120. Then, the second wireless network device 130 can connect to the wireless AP 110 for connecting to a network 140 through the wireless AP 110.

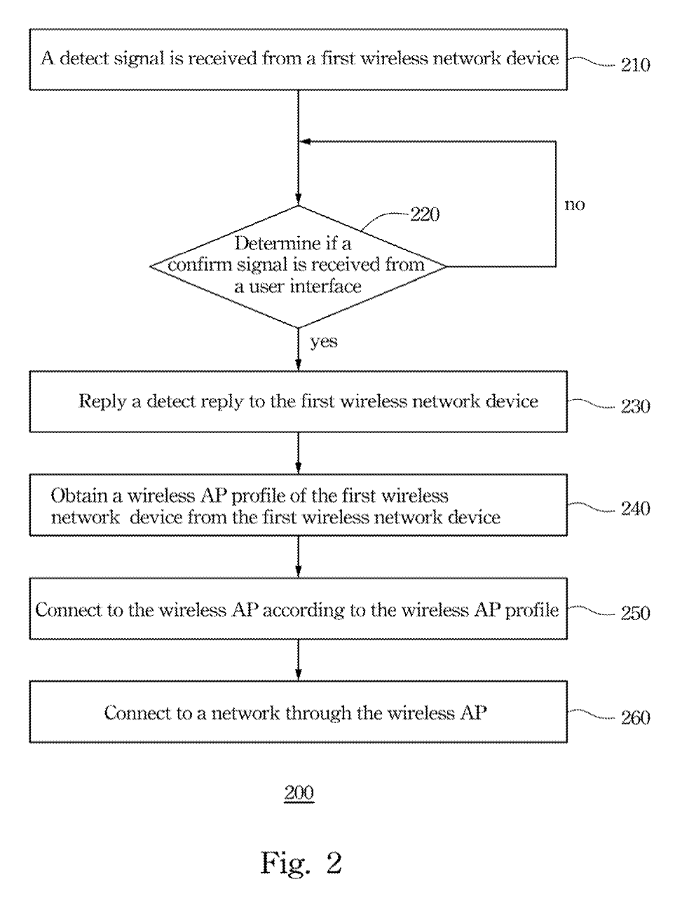

FIG. 2 is an embodiment of a wireless network connecting method executed in the second wireless network device 130 in FIG. 1. Refer to both FIG. 1 and FIG. 2. The wireless network connecting method 200 includes the following steps:

After a detect signal is received from a first wireless network device 120 (step 210), reply a detect reply to the first wireless network device 120 (step 230) to obtain a wireless AP profile of the first wireless network device 120 from the first wireless network device 120 (step 240). Wherein, the first wireless network device 120 connects to the wireless AP 110 according to the wireless AP profile of the first wireless network device 120. In addition, the steps of receiving the detect signal (step 210), replying the detect reply (step 230) and obtaining the wireless AP profile (step 240) are executed through Ad-hoc network. The wireless AP profile may include an AP Identifier (ID) of the wireless AP 110, an encryption method utilized by the wireless AP 110, a key to the encryption method utilized by the wireless AP 110, or any other information related to the wireless AP 110. Wherein, a Service Set Identifier (SSID) of the wireless AP 110 may be utilized as the AP ID of the wireless AP 110. The encryption method utilized by the wireless AP 110 may be Wired Equivalent Privacy (WEP), WiFi Protected Access (WPA), WPA2 or any other encryption method.

Before replying the detect reply to the first wireless network device 120 (step 230), the second wireless network device 130 may determine if a confirm signal is received from a user interface (step 220), such as a pre-defined button, a pre-defined key or any other pre-defined user interface. When the confirm signal is not received from the user interface, determine if the confirm signal is received from the user interface (step 220) repeatedly. Only when the confirm signal is received from the user interface, reply the detect reply to the first wireless network device 120 (step 230). In other words, the second wireless network device 120 won't reply the detect reply (step 230) only if a user generates the confirm signal through the user interface. Therefore, the wireless AP profile won't be obtained by another wireless network device without replying the detect reply.

In step 250, connect to the wireless AP 110 according to the wireless AP profile. Then, the second wireless network device 130 can connect to the network 140 through the wireless AP 110 (step 260). Wherein the connection in step 250 is executed through instructions of WiFi, IEEE 802.11 series (such as 802.11a, 802.11b, 802.11g, 802.11n or any other 802.11 family) or any other wireless network protocol. The network 140 may be Internet or Local Area Network (LAN).

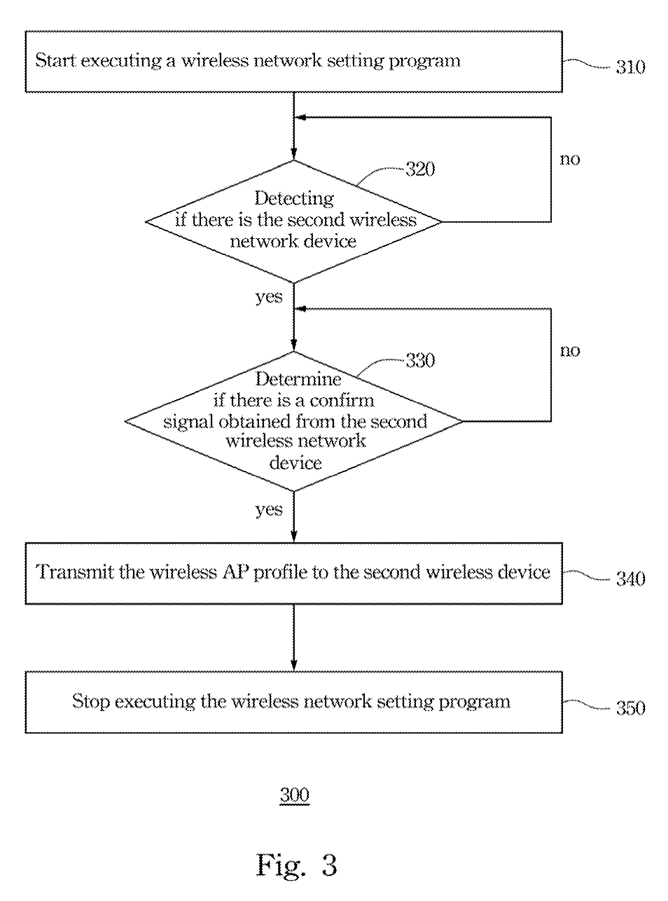

FIG. 3 is an embodiment of a wireless network setting method executed in the first wireless network device 120 in FIG. 1. Refer to both FIG. 1 and FIG. 3. On the other hand, the first wireless network device 120 transmits a wireless AP profile to the second wireless network device 130 after the second wireless network device 130 is detected by the first wireless network device 120. Then, the second wireless network device 130 can connect to the wireless AP 110 according to the wireless AP profile for connecting to the network 140 through the wireless AP 110. The wireless network connecting method 300 includes the following steps:

After the first wireless network device 120 starts executing a wireless network setting program (step 310), the first wireless network device 120 detects if there is the second wireless network device 130 (step 320) repeatedly. Wherein, the detection in step 320 may be implemented by receiving a wireless network ID repeatedly, and determining if the received wireless network ID is the same as a pre-defined device ID of the second wireless network device 130. The second wireless network device 130 is determined detected when the received wireless network ID is the same as the predefined device ID of the second wireless network device 130. Thus, for detection in step 320, the device ID of the second wireless network device 130 may be pre-defined. In addition, the detection in step 320 may be implemented by transmitting a detect signal repeatedly. Wherein, the second wireless network device 130 is determined detected when the detect reply is obtained. In other words, a specified signal can be pre-defined as the detect signal, which makes the second wireless network device 130 reply a detect reply for detection in step 320 after receiving the detect signal.

When the second wireless network device 130 is not detected, detect if there is the second wireless network device 130 (step 320) repeatedly. On the other hand, when the second wireless network device 130 is detected, transmit the wireless AP profile to the second wireless network device 130 (step 340), and stop executing the wireless network setting program (step 350). Then, the second wireless network device 130 can connect to the wireless AP 110 according to the wireless AP profile for connecting to the network 140 through the wireless AP 110. Wherein, the wireless AP profile may include an AP ID of the wireless AP 110, an encryption method utilized by the wireless AP 110, a key to the encryption method utilized by the wireless AP 110, or any other information related to the wireless AP 110. A SSID of the wireless AP 110 may be utilized as the AP ID of the wireless AP 110. The encryption method utilized by the wireless AP 110 may be WEP, WPA, WPA2 or any other encryption method. In addition, step 320 and step 340 can be executed through an Ad-hoc network.

Before the wireless AP profile is transmitted to the second wireless network device 130 (step 340), the first wireless network device 120 may determine if the wireless AP profile can be utilized for connecting to the wireless AP 110. Only when the wireless AP profile can be utilized for connecting to the wireless AP 110, the wireless AP profile can be transmitted to the second wireless network device 120 (step 340). Wherein, the determination above may be implemented by the first wireless network device 120 connecting to the AP 110 according to the wireless AP profile. The wireless AP profile is determined okay for connecting to the wireless AP 110 when the first wireless network device 120 connects to the wireless AP 110 according to the wireless AP profile successfully In addition, the determination mentioned above may be executed by instructions of WiFi, IEEE 802.11 series (such as 802.11a, 802.11b, 802.11g, 802.11n or any other 802.11 family) or any other wireless network protocol. Therefore, the wireless AP profile transmitted can be certified okay for connection to the wireless AP 110 after the determination mentioned above.

Moreover, when the second wireless network device 130 is detected, the first wireless network device 120 may determine if there is a confirm signal obtained from the second wireless network device 130 (step 330). The first wireless network 120 won't transmit the wireless AP profile only if the confirm signal is obtained from the second wireless network device 130. In addition, when the confirm signal is not obtained from the second wireless network device 130, the first wireless network device 120 may determine if there is the confirm signal obtained (step 330) repeatedly. Wherein, a confirm signal is generated by the second wireless network device 130 when a user operates a user interface, such as a pre-defined button, a pre-defined key or any other pre-defined user interface, of the second wireless network device 130. Therefore, even if other wireless network devices are mis-determined as the second wireless network device 130, the wireless AP profile won't be transmitted to such devices without the confirm signal.

Above all, a new wireless network device can connect to the wireless AP for network surfing according to the wireless AP profile obtained from other wireless network device. Therefore, when a wireless network device has been settled with a wireless AP profile to connect to a wireless AP, users don't need to input the wireless AP profile for wireless connection of a new wireless network device. In addition, the wireless AP profile can only be transmitted to a detected wireless network device with replying a confirm signal. Therefore, the wireless AP profile won't be transmitted to other wireless network device, which is mis-determined as the detected wireless network device, without replying the confirm signal.

Although the present invention has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A wireless network connecting and setting method, comprising:
transmitting a detect signal through a first wireless network device;
replying a detect reply to the first wireless network device when the detect signal is received by a second wireless network device;
transmitting a wireless access point (AP) profile of the first wireless network device, according to which the first wireless network device connects to a wireless AP, to the second wireless network device, and
connecting the second wireless network device to the wireless AP according to the wireless AP profile, such that the second wireless network device connects to a network through the wireless AP.

2. The wireless network connecting and setting method of claim 1, wherein the wireless AP profile is transmitted only when the wireless AP profile can be utilized for connecting to the wireless AP.

3. The wireless network connecting and setting method of claim 1, further comprising:
determining if a confirm signal is received from a user interface of the second wireless network device, wherein the detect reply is replied to the first wireless network device only when the confirm signal is received.

4. The wireless network connecting and setting method of claim 1, wherein the steps of transmitting the detect signals replying the detect reply and transmitting the wireless AP profile are executed through Ad-hoc network.

5. The wireless network connecting and setting method of claim 1, wherein the wireless AP profile comprises an AP Identifier (ID) of the wireless AP, an encryption method utilized by the wireless AP and a key to the encryption method utilized by the wireless AP.

6. The wireless network connecting and setting method of claim 1, wherein the step of connecting the second wireless network device to the wireless AP according to the wireless AP profile is executed through instructions of WiFi or IEEE 802.11 series.

7. The wireless network connecting and setting method of claim 1, wherein the network is Internet or Local Area Network (LAN).

8. A wireless network connecting method, executed by a first wireless network device, such that the first wireless network device obtains a wireless AP profile of a second wireless network device from the second wireless network device, and the first wireless network device connects to a wireless AP according to the wireless AP profile for network surfing, wherein the wireless network connecting method comprises:
receiving a detect signal from the second wireless network device;
replying a detect reply to the second wireless network device;
obtaining the wireless AP profile of the second wireless network device, according to which the second wireless network device connects to the wireless AP, from the second wireless network device; and
connecting to the wireless AP according to the wireless AP profile for connecting to a network through the wireless AP.

9. The wireless network connecting method of claim 8, further comprising;
determining if a confirm signal is received from a user interface, wherein the detect reply is replied only when the confirm signal is received.

10. The wireless network connecting method of claim 8, wherein the steps of receiving the detect signal, replying the detect reply and obtaining the wireless AP profile are executed through Ad-hoc network

11. The wireless network connecting method of claim 8, wherein the wireless AP profile comprises an AP ID of the wireless AP, an encryption method utilized by the wireless AP and a key to the encryption method utilized by the wireless AP.

12. The wireless network connecting method of claim 8, wherein the step of connecting to the wireless AP according to the wireless AP profile is executed through instructions of WiFi or IEEE 802.11 series.

13. The wireless network connecting method of claim 8, wherein the network is Internet or LAN.

14. A wireless network setting methods executed by a first wireless network device, such that the first wireless network device transmits a wireless AP profile of the first wireless network device to a second wireless network device to make the second wireless network device connect to a wireless AP according to the wireless AP profile for network surfing, wherein the wireless network setting method comprises:
executing a wireless network setting program;
detecting if there is the second wireless network device;
determining if the wireless AP profile can be utilized for connecting to the wireless AP; and
only when there is the second wireless network device detected and the wireless AP profile can be utilized for connecting to the wireless AP, transmitting the wireless AP profile to the second wireless network device, such that the second wireless network device connects to the wireless AP according to the wireless AP profile for connecting to a network through the wireless AP.

15. The wireless network setting method of claim 14, wherein the step of transmitting the wireless AP profile to the second wireless network device when there is the second wireless network device detected comprises:
transmitting a confirm request to the second wireless network device when there is the second wireless network device detected, such that a confirm signal is obtained from the second wireless network device, and
transmitting the wireless AP profile to the second wireless network device only when the confirm signal is obtained.

16. The wireless network setting method of claim 14, wherein the step of detecting if there is the second wireless network device comprises:
receiving a wireless network ID; and
determining if the wireless network ID is the same as a pre-defined device ID of the second wireless network device, wherein the second wireless network device is determined detected when the wireless network ID is the same as the pre-defined device ID of the second wireless network device.

17. The wireless network setting method of claim 14, wherein the step of detecting if there is the second wireless network device comprises:
transmitting a detect signals, such that a detect reply is obtained from the second wireless network device; and
the second wireless network device is determined detected when the detect reply is obtained.

18. The wireless network setting method of claim 14, wherein the steps of detecting if there is the second wireless network device and transmitting the wireless AP profile to the second wireless network device are executed through Ad-hoc network.

19. The wireless network setting method of claim 14, the wireless AP profile comprises an AP ID of the wireless AP, an encryption method utilized by the wireless AP and a key to the encryption method utilized by the wireless AP.

20. The wireless network setting method of claim 14, wherein the step of connecting to the wireless AP according to the wireless AP profile is executed through instructions of WiFi or IEEE 802.11 series.
